(19) United States
(12) Patent Application Publication
(10) Pub. No.: US 2006/0259395 A1
(43) Pub. Date: Nov. 16, 2006

(54) Initiating orders to buy or sell tradeable objects

(75) Inventor: Michael J. Burns, Chicago, IL (US)

Correspondence Address: MBHB/TRADING TECHNOLOGIES, 300 SOUTH WACKER DRIVE, SUITE 3200, CHICAGO, IL, 60606, US

(73) Assignee: Trading Technologies International, Inc.

(21) Appl. No.: 11/415,411

(22) Filed: May 1, 2006

Related U.S. Application Data
(63) Continuation of application No. 11/026,779, filed on Dec. 31, 2004.

(51) Int. Cl. G06Q 40/00

(52) U.S. Cl. 705/37

(57) ABSTRACT

A system and method for providing order entry devices which are tailored for use in an electronic trading environment are described herein. To assist traders in performing at their most optimum levels, some of the preferred order entry devices include only input mechanisms tailored for fast data entry into a trading terminal. In addition, some of the preferred order entry devices also include output display mechanisms to display market information in direct association with the input mechanisms. The order entry devices may be only a hardware solution or a combination of hardware and software components to allow traders to successfully interface with any particular type of trading software or application.

### FIELD OF INVENTION

The present invention is directed towards electronic trading, and more specifically, is directed to a system and method for initiating orders to buy or sell tradeable objects.

### BACKGROUND

An electronic exchange typically provides an automatic matching process between traders, or more specifically between buyers and sellers. Traders are connected to an electronic exchange by way of a communication link to facilitate electronic messaging between themselves and the exchange. Market information is included in the messaging and is displayed to the traders on their trading screens. Upon viewing the market information, traders can take certain actions including the action of sending buy or sell orders to the exchange.

In many instances, spotting an opportunity in the market and capitalizing on it before the competition does can separate those traders who are successful and those traders who are not. Therefore, an important component in capitalizing on an opportunity involves the time it takes to send an order to the market, in hopes that your order has time priority, or some other priority, over the competition. Unfortunately, traders still use conventional, multi-purpose input devices such as a keyboard or mouse to enter and send their orders to the exchange.

Take for example the computer keyboard, which is a well-known input device used in entering data into a computer. The keys on a computer keyboard are essentially the same as the typewriter-like keys of the original typewriters, with the exception of a few additional keys. The standard layout of a computer keyboard typically has letters, numbers, and punctuation so that general data can be entered into a computer. However, the keyboard is designed for multipurpose use, not necessarily for high-performance trading where time is of the essence.

The mouse is also a well-known multi-purpose input device. The mouse is a device that controls the movement of a cursor or pointer on a screen or display. The mouse device itself can be moved along a flat surface such that as it is moved the cursor on the screen is also moved in the same direction. Although there are many advantages to using a mouse, such as the direct relationship between hand and cursor movement and its generally easy to use, there are also disadvantages. In some instances, to trade using a mouse, the trader must drag the cursor to desired locations corresponding to certain order parameters such as price and/or quantity. What might seem like a simple means for inputting data into a computer, however, dragging the cursor across the screen to a specific location is not always so simple and intuitive especially during times of panic or fast moving action. In addition, if the cursor is not precisely situated over a particular location, the order may be pre-loaded or sent to the exchange with the wrong order parameters.

Both the keyboard and the mouse, and other types of similar input devices, are useful input tools in the field of trading, but because they are configured more for multipurpose use, they are not necessarily tailored for assisting a trader in competitive, high-performance trading. What is needed then is an input device that is configured for trading. An input device that is tailored to order entry can provide a trader with many additional advantages over conventional input means so that he or she can better profit in the electronic markets.

### BRIEF DESCRIPTION OF THE DRAWINGS

FIG. 1 is a block diagram that illustrates an electronic trading system showing a network connection between client devices and electronic exchanges;

FIG. 2 is a block diagram that illustrates a software/hardware overview of an example client device with an order entry device in accordance with the preferred embodiments for use in a system such as shown in FIG. 1;

FIG. 3 is a block diagram that illustrates a software/hardware overview of an example client device with another type of order entry device in accordance with the preferred embodiments for use in a system such as shown in FIG. 1;

FIG. 4 shows an example illustration of an order entry device and how the keys of the order entry device might be mapped to price levels;

FIG. 5 shows the example illustration of the order entry device in FIG. 4 except that the keys of the order entry device are mapped to different price levels as a result from an action by a trader to change the mapping;

FIG. 6 shows another example of a particular trading screen that may be used with the preferred embodiments, and in particular, illustrates how the keys might be mapped to price levels displayed in the trading screen;

FIG. 7 shows an example illustration of an order entry device that has keys mapped to a series of price levels;

FIG. 8 shows an example illustration of an order entry device like that shown in FIG. 7 with the addition of an output display screen;

FIG. 9 shows an example illustration of yet another order entry device;

FIG. 10 shows an example illustration of an order entry device like that shown in FIG. 7 with the addition of an output display screen;

FIG. 11 shows an order entry device that utilizes touch screen technology;

FIG. 12 shows an example illustration of an order entry device with the addition of an output display that uses a trading screen of the type shown in FIG. 6;

FIG. 13 shows an order entry device with a horizontal arrangement of keys; and

FIG. 14 shows an order entry device of the type shown in FIG. 13 with the addition of an output display screen.

### DETAILED DESCRIPTION

I. Overview

It is generally important to the success of a trader that he or she can quickly assess a market and then react almost immediately to send an order to buy or sell a tradeable object. However, as stated in the background section above, conventional input devices which have been used to send buy or sell orders are devices which have been designed for multi-purpose use and they have not been specifically tailored for use in trading. Even so, traders of all types still use these conventional means for sending orders to an exchange or managing these orders. Unfortunately, order entry such an important element of trading has been given little attention, even though the right input devices may make the difference between a trader who is a success or a failure.

To assist traders in performing at their most optimum levels, order entry devices which are tailored for use in an electronic trading environment are described herein. The order entry devices may be only a hardware solution or a combination of hardware and software components to allow traders to successfully interface with trading software. Some of the preferred order entry devices include only input mechanisms tailored for fast data entry into a trading terminal. If so desired, such order entry devices may be used with other third party display devices like a trading screen to display market data. In addition, some of the preferred order entry devices also include output display mechanisms to display market information in direct association with the input mechanisms.

One skilled in the art of trading would appreciate the benefits of the present invention and could recognize its advantages from the teachings described herein. For example, by providing an input device tailored to trading, a trader may make accurate trades in a faster and more efficient manner than using conventional input devices designed for multi-purpose use. The preferred embodiments now will be described more fully hereinafter with reference to the accompanying drawings. This invention may, however, be embodied in many different forms and should not be construed as limited to the preferred and/or example embodiments set forth herein.

II. Preferred System Architecture

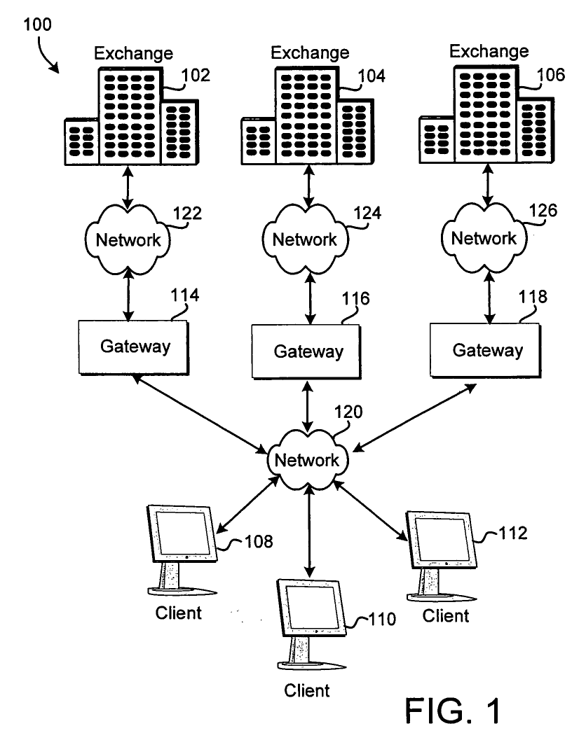

FIG. 1 is a block diagram that illustrates an electronic trading system 100 in accordance with the preferred embodiments. The system 100 includes one or more exchanges 102, 104, 106 and one or more client devices 108, 110, 112. Intermediate devices such as gateways 114, 116, 118, routers (not shown in the Figure for sake of clarity), and other such types of network devices may be used to connect network 120 to networks 122, 124, 126 so that client devices 108, 110, 112 and exchanges 102, 104, 106 can communicate market information. It should be understood that the present invention is not limited to any particular system configuration. For example, networks 122, 124, and 126 could represent the same network, network 120 could represent the same network as networks 122, 124, and 126, or client devices 108, 110, 112 could connect separately to gateways 114, 116, 118. Of course, the preferred embodiments may be implemented on many other system configurations.

A. Exchange

Any of exchanges 102, 104, 106 may represent, for example, the London International Financial Futures and Options Exchange (LIFFE), the Chicago Board of Trade (CBOT), the Chicago Mercantile Exchange (CME), the Exchange Electronic Trading (“Xetra,” a German stock exchange), or the European Exchange (“Eurex”), or any other exchange that participates in electronic trading. Exchanges 102, 104, 106 might also refer to other facilities, which include basic to more complex systems that automatically match incoming orders. These example exchanges and other exchanges are well known in the art. Communication protocols required for connectivity to one of these exchanges are also well known in the art.

Exchanges 102, 104, 106 allow traders to log onto a market to trade tradeable objects. As used herein, that the term “tradeable objects,” refers simply to anything that can be traded with a quantity and/or price. It includes, but is not limited to, all types of traded events, goods and/or financial products, which can include, for example, stocks, options, bonds, futures, currency, and warrants, as well as finds, derivatives and collections of the foregoing, and all types of commodities, such as grains, energy, and metals. The tradeable object may be “real,” such as products that are listed by an exchange for trading, or “synthetic,” such as a combination of real products that is created by the user. A tradeable object could actually be a combination of other tradeable object, such as a class of tradeable objects.

An exchange 102, 104, 106 can implement numerous types of order execution algorithms, sometimes the type of algorithm depends on the tradeable object being traded. Preferably, the preferred embodiments can be adapted by one skilled in the art to work with any particular order execution algorithm. Some example order execution algorithms include first-in-first-out and pro rata algorithms. The first-in-first-out (FIFO) algorithm, used for some markets listed with Eurex for example, gives priority to the first person to place an order. The pro rata algorithm, used for some markets listed with LIFFE for example, splits all orders for the same price. The present invention is not limited to any particular type of order execution algorithm.

Regardless of the type of order execution algorithm used, each exchange 102, 104, 106 preferably provides similar types of information to subscribing client devices 108, 110, 112. Market information may include data that represents just the inside market. The inside market is the lowest sell price (best ask) and the highest buy price (best bid) at a particular point in time. Market information may also include market depth. Market depth refers to quantities available at the inside market and can also refer to quantities available at other prices away from the inside market. The quantity available at a given price level is usually provided by the host exchange in aggregate sums. In other words, an exchange usually provides the total buy quantity and the total sell quantity available in the market at a particular price level in its data feed. The extent of the market depth available to a trader usually depends on the exchange. For instance, some exchanges provide market depth for all (or most) price levels, while some provide only quantities associated with the inside market, and others may provide no market depth at all. Additionally, exchanges 102, 104, 106 can offer other types of market information such as the last traded price (LTP), the last traded quantity (LTQ), and order fill information.

B. Gateway

Gateways 114, 116, 118 are devices such as a mainframe, super minicomputer, minicomputer, workstation, microcomputer that connect network 120 to networks 122, 124, 126 so that market information can be successfully passed between client devices 108, 110, 112 and exchanges 102, 104, 106. Gateways 114, 116, 118 receive market information from exchanges 102, 104, 106 and convert it to a form compatible with the protocols used by client devices 108, 110, 112 using conversion techniques known in the art. Also, as known by those skilled in the art, gateways 114, 116, 118 may have one or more servers to support the data feeds, such as a price server for processing price information, an order server for processing order information, and a fill server for processing fill information. A trader at one of client devices 108, 110, 112 can subscribe to price information, order information, and fill information for a particular market hosted at exchanges 102, 104, 106. Gateways 114, 116, 118 also receive transaction information, such as orders, order changes, queries, etc. from client devices 108, 110, 112 and forward that information to corresponding exchanges 102, 104, 106.

C. Client Device

Client devices 108, 110, 112 are devices that provide an interface for traders to trade at one or more markets listed with one, some, or all of exchanges 102, 104, 106. Some examples of client devices include a personal computer, laptop computer, hand-held computer, and so forth. Client devices 108, 110, 112, according to the preferred embodiments, include at least a processor and memory. The processor and memory, which are both well known computer components, are not shown in the Figure for sake of clarity. Preferably, the processor has enough processing power to handle and process the various types of market information. Of course, the more market information which is received and processed, the more processing power is preferred. However, any present day processor has enough capability to perform at least the most basic part of the present invention.

Memory may include computer readable medium. The term computer readable medium, as used herein, refers to any medium that participates in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory or RAM (random access memory). Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, and any other memory chip or cartridge, or any other medium from which a computer can read.

Client devices 108, 110, 112 receive market information from any of exchanges 102, 104, 106. According to the preferred embodiments, market information is displayed to the trader(s) on the visual output device or display device. According to one embodiment, the output device can be any type of display, such as from a third party vendor. For example, the display could be a CRT-based video display, an LCD-based or a gas plasma-based flat-panel display, a display that shows three-dimensional images, or some other type of display. According to another embodiment, the display is integrated with an input mechanism.

Upon viewing the market information or a portion thereof, a trader may wish to send orders to an exchange, cancel orders in a market, change orders in a market, query an exchange, and so on. To do so, the trader may input various commands or signals into the client device 104, for example, by using one of the preferred order entry devices described herein. Additional and more conventional means for inputting information may include typing into a keyboard, inputting commands through a mouse, or inputting commands or signals through some other well-known multi-purpose input device.

Upon receiving one or more commands or signals, client devices 108, 110, 112 preferably generate transaction information. For instance, a trader may press a key or button to initiate an order to buy a tradeable object. Then, transaction information would include an order to buy a particular quantity of the tradeable object at a particular price. There are many different types of messages and/or order types that can be submitted, all of which may be considered various types of transaction information. Once generated, transaction information is sent from client device 104 to host exchange 102 over network(s) 120, 122, 124, 126.

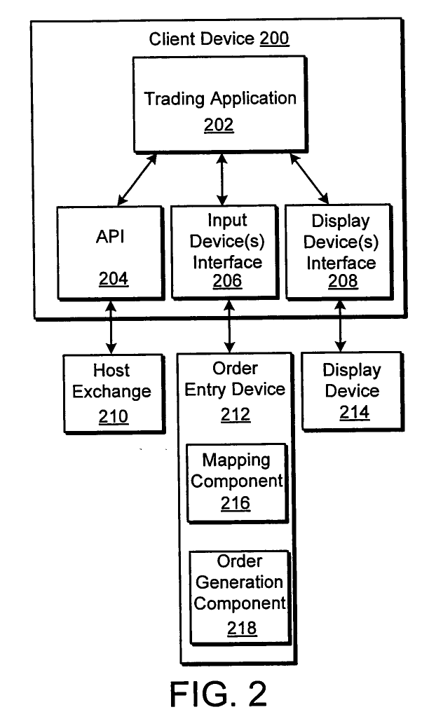

FIG. 2 shows an overview of client device 200 which may be similar to the type of client devices 108, 110, 112 shown in FIG. 1. Client device 200 can be any particular type of computing device, examples of which were enumerated above with respect to the client devices. According to the preferred embodiments, client device 200 has trading application 202 stored in memory that when executed it may arrange and display market information in many particular ways, usually depending on how the trader prefers to view the information. Preferably, trading application 202 has access to market information through API 204 (or application programming interface) and trading application 202 can also forward transaction information to exchange 210 via API 204. Alternatively, API 204 could be distributed so that a portion of the API rests on the client device 200 and a gateway, or at the exchange 210.

III. Order Entry Devices

The preferred embodiments may be implemented as input-only devices, or they may be implemented as a combination of input and output devices. The trader may choose which type of order entry device best suits his or her needs, for example, one that is input-only or one that is a combination of both input and output. Regardless of the type of order entry device chosen, the preferred order entry devices provide traders with more intuitive control over their order entry process.

Referring to FIG. 2, according to input-only devices, trading application 202 may receive signals from an order entry device 212 of the preferred embodiments via input device interface 206. Also, the trading application 202 may be programmed to send signals (e.g., video/audio signals) to display device 214 via display device interface 208. As previously mentioned, the display device 214 can be any type of display, such as from a third party vendor. Example displays could include a CRT-based video display, an LCD-based or a gas plasma-based flat-panel display, a display that shows three-dimensional images, or some other type of display. Order entry device 212 can communicate with a client device 200 using standard protocols such as USB (Universal Serial Bus) and PS/2, using a proprietary protocol, or some other protocol. The order entry device 212 includes a mapping component 216 and an order generation component 218. According to one example embodiment, the mapping component 216 establishes an association between a plurality of buttons, keys, or yet some other input means of the order entry device 212 and a plurality of price levels that can be used to trade a tradeable object at an electronic exchange. As will be explained in relation to subsequent figures, the mapping component can either establish a fixed or dynamic association between the plurality of keys with a plurality of prices. When the fixed association is used, the mapping component can establish a new fixed association between each price level and the keys upon receiving a re-positioning command (e.g., from a user initiated command or a program initiated command) in relation to the price levels being displayed on a trading interface. By providing a fixed association of prices and buttons, when a trader goes to select a button, the trader can know, with confidence, the price associated with the soon-to-be selected button. In other words, the associated price will not change under the trader's finger, for example.

Also, as will be described in greater detail below, each price level can be associated with two buttons on the order entry device, and each of the two buttons can be associated with either buying the tradeable object or selling the tradeable object at the corresponding price. In such an embodiment, in response to a selection of button, the order generation component 218 can determine the association between the selected button and one of the plurality of prices, and whether the selected button corresponds to buying or selling the tradeable object. When the selected button corresponds to buying the tradeable object, the order generation component 218 can send an order to buy the tradeable object at the determined price to an electronic exchange. Similarly, when the selected button corresponds to selling the tradeable object, the order generation component can send an order to sell the tradeable object at the determined prices to the electronic exchange.

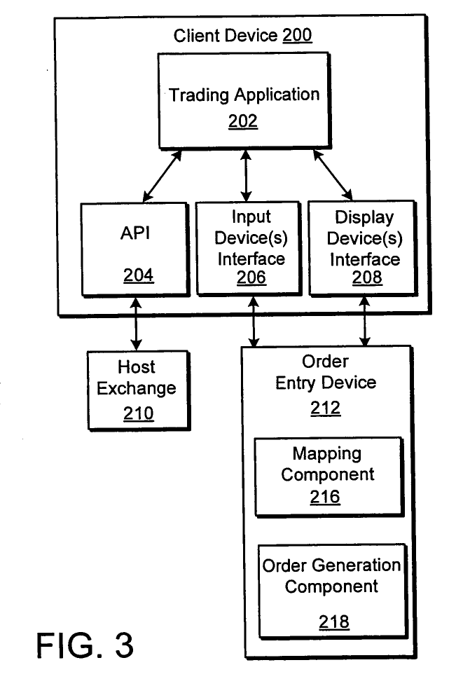

FIG. 3 shows an overview of client device 200 (e.g., previously shown in FIG. 2) and connected to the client device 200 in FIG. 3 is an order entry device 216 that has both input and output. Trading application 202 may receive signals from an order entry device 216 via input device interface 206 and the order entry device 216 may receive signals from trading application 202 via display device interface 208. Order entry device 216 can communicate with client device 200 using standard protocols such as USB (Universal Serial Bus) and PS/2, using a proprietary protocol, or some other protocol.

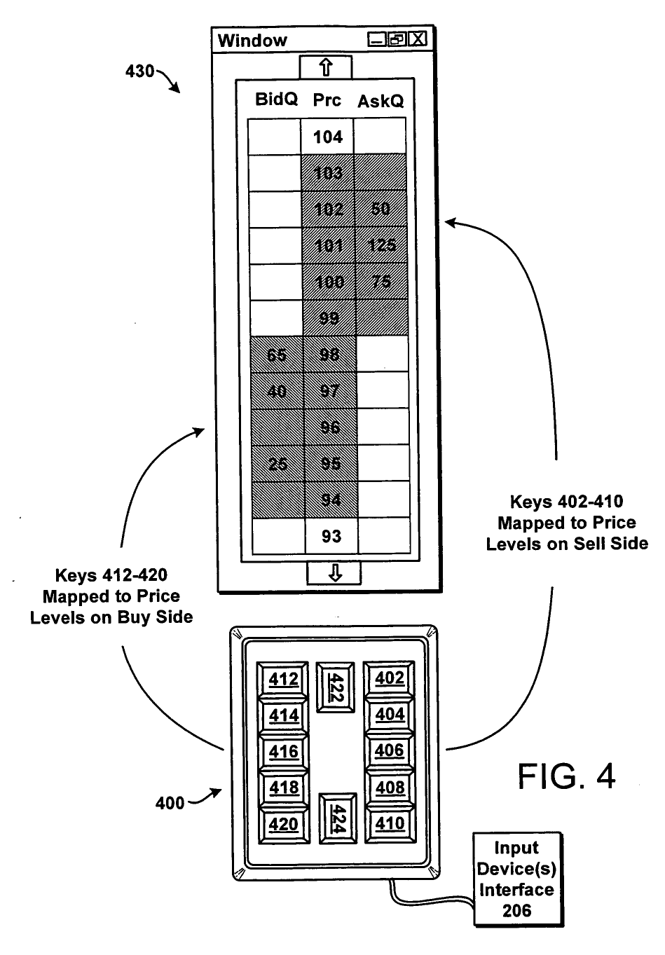

FIG. 4 shows an order entry device 400 with keys mapped to various price levels. It should be understood that keys are only one example, and buttons or yet other graphical or physical object could also be used in relation to the order entry devices described herein. Order entry device 400 is of the only-input type and may be connected to an input device(s) interface (e.g., 206 in FIG. 2). Preferably each of the keys 402-420 is mapped to a particular price level for which orders can be placed. An advantage of using keys 402-420 is the tactile feedback which can be achieved for each of the key's actuation. Then, for example, a trader can spot an opportunity at a particular price level and quickly press the key which is mapped directly to the price level to send an order to market. Preferably, the tactile feedback allows the trader to be confident that a key has been depressed and that an order has been commanded to be sent to the exchange. Of course, other types of buttons or equivalent input mechanisms that preferably provide similar types of tactile feedback to keys may be used. Also, order entry device 400 can have more or fewer number of keys than shown in the Figure. It should also be understood that the system, according to all embodiments, may be programmed to send an order upon depression of a button or upon depression and release of the button; the description herein may use either method interchangeably.

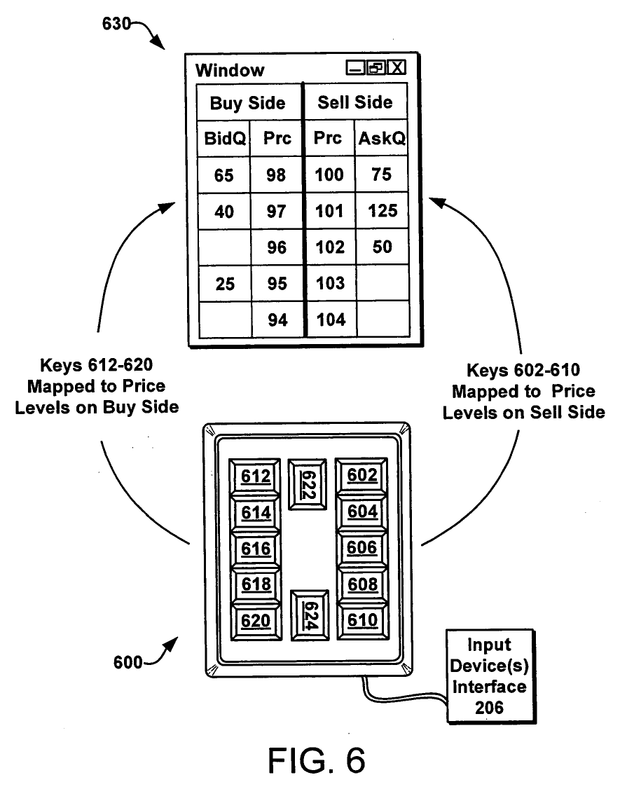

For ease of explaining how keys 402-420 might be mapped to various price levels, a trading screen 430 is also shown in FIG. 4. Trading screen 430 might be generated by a trading application (e.g., trading application 202 in FIG. 2) and displayed on a monitor or some other display screen. A commercially available trading application that allows a user to trade in a system like that shown in trading screen 430 is X_TRADER® from Trading Technologies International, Inc. of Chicago, Ill. X_TRADER® also provides an electronic trading interface, referred to as MD Trader™, in which working orders and/or bid and ask quantities are displayed in association with a price scale or axis. Portions of the X_TRADER® and the MD Trader™-style display are described in U.S. Pat. No. 6,772,132 entitled “Click Based Trading With Intuitive Grid Display of Market Depth,” filed on Jun. 9, 2000, U.S. patent application Ser. No. 09/971,087, entitled “Click Based Trading With Intuitive Grid Display of Market Depth and Price Consolidation,” filed on Oct. 5, 2001, and U.S. patent application Ser. No. 10/125,894, entitled “Trading Tools for Electronic Trading,” filed on Apr. 19, 2002, the contents of each are incorporated herein by reference. It should be understood that any trading screen, whether or not there is a price scale or axis, may be used with the present invention. For example, a trading screen without a price axis is shown in FIG. 6.

Preferably, a fixed association is established between the plurality of prices on the trading interface 430 and the plurality of buttons of the order entry device 400. According to one example embodiment, the association between the buttons and prices is not modified until a repositioning command is detected in relation to the trading interface 430. The repositioning command can be a user initiated command or an automatic command initiated by a software program. When the repositioning command is received, a new fixed association between the buttons of the order entry device 400 and the prices on the trading interface 430 is established.

Referring to FIG. 4, to illustrate how order entry device 400 might operate according to the preferred embodiments assume that the best ask price is 100 and the best bid price is 98. This market information is also reflected in trading screen 430. Keys 402-410 might represent the sell side and keys 412-420 might represent the buy side (or vice versa). Assume at startup, keys 402-420 were mapped to price levels centered around the inside market prices (note that at startup, the keys may be centered around a different reference point other than the inside market prices, for example, they could be centered around the last traded price or a theoretical value electronically fed into the preferred system). Tables 1 and 2 show one example of mapping the keys to price levels. The price levels are highlighted in trading screen 430.

TABLE 1

| Key | Price Level | Relation to Inside Market |
|---|---|---|
| 402 | 99 | In between Inside Market |
| 404 | 100 | Best Ask Price |
| 406 | 101 | 1 tick unit above |
| 408 | 102 | 2 tick units above |
| 410 | 103 | 3 tick units above |

TABLE 2

| Key | Price Level | Relation to Inside Market |
|---|---|---|
| 412 | 98 | Best Bid Price |
| 414 | 97 | 1 tick unit below |
| 416 | 96 | 2 tick units below |
| 418 | 95 | 3 tick units below |
| 420 | 94 | 4 tick units below |

Referring to Table 1, key 402 corresponds to “99” which is one price level below the best ask price (where a price level can have any units, such as a minimum price unit offered by an exchange, some pre-set price unit, a consolidated price unit, or some other unit of measurement). When key 402 is pressed, or more generally, when a key which is mapped to a price level in between the inside market is pressed, the software is preferably programmed to either send no orders, an order to buy, or an order to sell depending on how the trader wants the order entry system to be configured. For example, a trader might wish not to better the market and would therefore prefer to send no orders at a price level in between the inside market. In another example, a trader might wish to send sell orders at a price level in between the inside market if the price level is greater than the last traded price, and the trader might wish to send buy orders at the price level if the price level is less than the last traded price. Of course, there are other ways to configure the order entry system to determine what action occurs as a result of pressing a key that corresponds to a price level which falls in between the inside market prices.

Alternatively, keys 402-420 could be mapped in such a way as to not have a key that corresponds to a price level in between the inside market prices. According to this embodiment, for example, key 402 might instead correspond to the best ask price or “100,” key 404 would correspond to “101,” key 406 would correspond to “102,” key 408 would correspond to “103,” and key 410 would correspond to “104.” Accordingly, no key would be assigned to “99.”

Referring to Table 2, key 412 corresponds to “98” which is the best bid price using the current fact scenario. According to Table 2, key 414 corresponds to “97,” key 416 corresponds to “96,” key 418 corresponds to “95,” and key 420 corresponds to “94.” Again, it should be understood that how the price levels are assigned to the keys are completely arbitrary and preferably dependent on the trader's preferences. For example, key 412 could instead be programmed to correspond to “99.”

In addition, according to the preferred embodiments, the price levels which are currently mapped to the keys may be highlighted on the trading screen for viewing by a trader. Therefore, using the current mapping set forth in Tables 1 and 2, price levels “99” through “103” and their associated ask quantities are preferably highlighted to indicate that keys 402-410 are mapped those price levels. And price levels “98” through “94” and their associated bid quantities are highlighted to indicate that keys 412-420 are mapped to those price levels. Preferably, the highlighting on the trading screen changes to correspond to changes in the mapping.

Tables 1 and 2 show a mapping of keys 402 and 412 to price levels either at or near the inside market, while each key thereafter equates to one tick level away (e.g., either below or above one of the inside market prices) from those starting price levels. Alternatively, keys 402-420 may be mapped such that keys 410 and 420 (instead of keys 402 and 412 in the earlier discussion) correspond to price levels at or near the inside market. Tables 3 and 4 show an example illustration of this alternative mapping scheme to Tables 1 and 2.

TABLE 3

| Key | Price Level | Relation to Inside Market |
|---|---|---|
| 402 | 103 | 3 tick units above |
| 404 | 102 | 2 tick units above |
| 406 | 101 | 1 tick unit above |
| 408 | 100 | Best Ask Price |
| 410 | 99 | In between Inside Market |

TABLE 4

| Key | Price Level | Relation to Inside Market |
|---|---|---|
| 412 | 94 | 4 tick units below |
| 414 | 95 | 3 tick units below |
| 416 | 96 | 2 tick units below |
| 418 | 97 | 1 tick unit below |
| 420 | 98 | Best Bid Price |

Once keys are mapped, a user can send an order for a pre-determined quantity by simply selecting one of the keys 402-420. The pre-determined or pre-set quantity may be entered into the system via conventional input devices such as a keyboard, mouse, and so on, or alternatively, the input devices of the preferred embodiments may have an input mechanism for setting such parameters. Other order parameters such as type of order may also be entered into the system via conventional input devices, or alternatively, through the input devices of the preferred embodiments. For example, additional keys or trackball may be added to the input devices of the preferred embodiments to allow for entry of additional order parameters.

To send an order to market, for example, according to the mapping shown in Tables 1 and 2, if a trader pressed key 404, then an order to sell a quantity equal to a pre-set quantity at price of “100” is sent to the exchange. If the trader pressed key 406, then an order to sell a quanity equal to a pre-set quantity at a price of “101” is sent to the exchange, and so on. If the trader pressed key 412, then an order to buy a quantity equal to a pre-set quantity at price of “98” is sent to the exchange. If the trader pressed key 414, then an order to buy a quantity equal to a pre-set quantity at price of “97” is sent to the exchange, and so on.

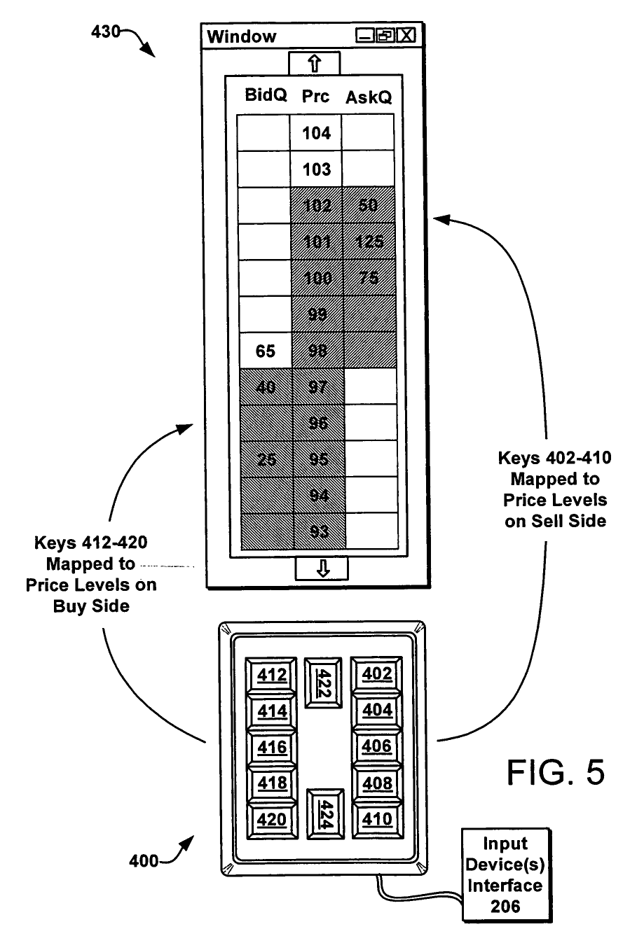

A trader might also want the option to scroll along price levels or essentially change the mapping of the keys to the price levels. According to one example embodiment, to do this, keys 422 and 424 can be used, such that key 422, when pressed, map keys 402-420 to price levels one tick higher and key 424, when pressed, maps keys 402-420 to price levels one tick lower. For example, if key 424 was pressed, the mapping would preferably change from that found in Tables 1 and 2 to that shown in Tables 5 and 6. Preferably, the highlighting on the screen changes to visually indicate to the trader the new mapping. FIG. 5 shows a change in highlighting to indicate a change in mapping by one-tick level.

TABLE 5

| Key | Price Level | Relation to Inside Market |
|---|---|---|
| 402 | 98 | Best Bid Price |
| 404 | 99 | In between Inside Market |
| 406 | 100 | Best Ask Price |
| 408 | 101 | 1 tick unit above |
| 410 | 102 | 2 tick units above |

TABLE 6

| Key | Price Level | Relation to Inside Market |
|---|---|---|
| 412 | 97 | 1 tick unit below |
| 414 | 96 | 2 tick units below |
| 416 | 95 | 3 tick units below |
| 418 | 94 | 4 tick units below |
| 420 | 93 | 5 tick units below |

Referring to Table 5, the best bid price and the best ask price are assigned to keys in the same group of keys (e.g., group of keys 402-410) as a result of changing the mapping. If so desired, to avoid having this occur, it is envisioned that each group of keys (e.g., group of keys 402-410 and group of keys 412-420) is mapped to price levels which are associated only with price levels on either the buy side or the sell side. So, for example, as a result of changing the mapping, Tables 7 and 8 show a possible mapping of keys to price levels where each group of keys is limited to either the buy side or the sell side.

TABLE 7

| Key | Price Level | Relation to Inside Market |
|---|---|---|
| 402 | 98 | No Assigned Action |
| 404 | 99 | No Assigned Action |
| 406 | 100 | Best Ask Price |
| 408 | 101 | 1 tick unit above |
| 410 | 102 | 2 tick units above |

TABLE 8

| Key | Price Level | Relation to Inside Market |
|---|---|---|
| 412 | 98 | Best Bid Price |
| 414 | 97 | 1 tick unit below |
| 416 | 96 | 2 tick units below |
| 418 | 95 | 3 tick units below |
| 420 | 94 | 4 tick units below |

FIG. 6 shows another example of trading screen 630 that may be used with the preferred embodiments, and in particular, illustrates how keys 602-620 of device 600 might be mapped to price levels for a given type of screen. In general, the information shown in trading screen 630 is the same market information as shown in FIGS. 4 and 5. However, trading screen 630 is dynamic in nature. In other words, screen 630 keeps the inside market prices (e.g., best bid is “98” and best ask is “100”) at the top of the columns and changes the prices accordingly to reflect price changes in the market. A similar trading screen with dynamic price movement is described in U.S. patent application Ser. No. 09/589,751, entitled “Click Based Trading With Market Depth Display,” filed on Jun. 9, 2000, the contents of which is incorporated by reference herein.

According to one embodiment, keys 602-620 might be mapped to price levels that are displayed in trading screen 630. Trading screen 630 in FIG. 6 shows the inside market prices and price levels up to four ticks away from the inside market prices. Then, for example, keys 602-610 could be mapped to price levels “100” through “104” and keys 612-620 could be mapped to price levels “98” through “94.” When the price levels change due to changing market conditions, the market information displayed in trading screen 630 would change and the mapping would preferably also change. It should be understood that a user can have the ability to switch between the dynamic nature of price assignments to keys on the input device 600, as well as any other input devices described hereinafter, and the static nature of price assignment, such as the one described in relation to FIG. 4. Many different methods could be used to enable a user to switch between the two configurations. For example, any user configured input could be used to trigger the switch between the two configurations. Alternatively, a switch could be provided in relation to the input device to enable the user to control the mode of the price assignments.

It should also be understood that some trading screens do not show all price levels up to a certain number of ticks away from the inside market. According to these trading screens, price levels that correspond to gaps in the market where there is no available quantity are not shown. In which case, price levels “94,” “96,” “103,” and “104” might not be displayed because currently they do not have quantity. Then, only price levels with quantity would be displayed. Often, these screens are used to save screen space or perhaps because the trader is interested in only trading in price levels which are currently active.

Using trading screens that do not display gaps, the keys can be mapped in different ways to accommodate a particular trading style. According to one embodiment, a key for the best bid and for each price thereafter could be mapped to a key. This refers to the example above where keys 602-610 are mapped to price levels “100” through “104” and keys 612-620 could be mapped to price levels “98” through “94.” This type of mapping would occur whether or not the price levels are actually displayed in the trading screen. In other words, the keys are always mapped to the inside market prices and at each price level above/below the inside market for up to a certain number of ticks. According to a another embodiment, a key is mapped only to the price levels displayed in the trading screen. This type of mapping scheme is dependent on the price levels actually displayed on the screen. For example, if the sell side had displayed only price levels “100,” “101,” and “104,” then key 602 could be mapped to “100,” key 604 could be mapped to “101,” and key 606 could be mapped to “104.” If the buy side had displayed only price levels “98,” “97,”, “95,” and “94,” then key 612 could be mapped to “98,” key 614 could be mapped to “97,” key 616 could be mapped to “95,” and key 618 could be mapped to “94.”

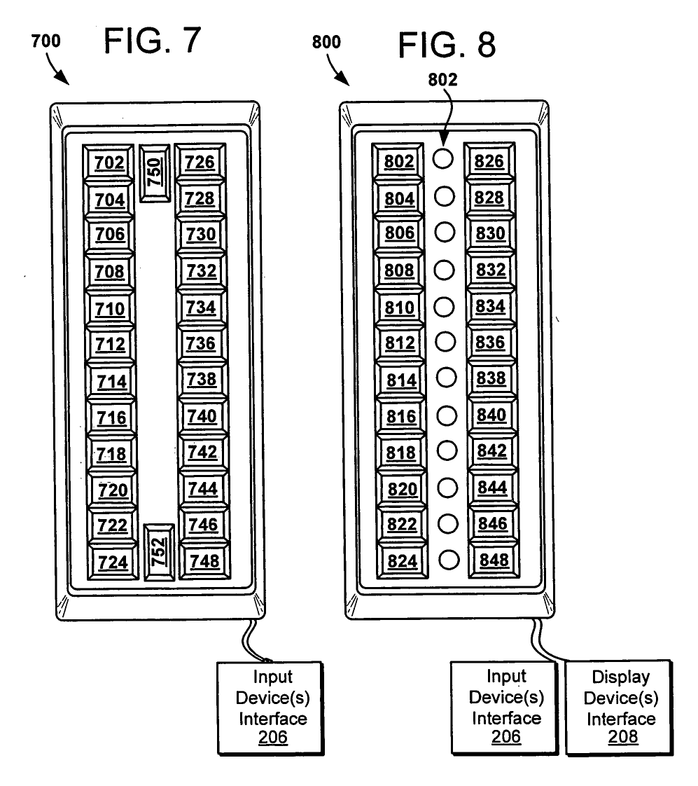

FIG. 7 shows another order entry device 700 that has keys mapped to a series of price levels. Similar to order entry device 400 of FIG. 4, order entry device 700 of FIG. 7 is of the only-input type and may be connected to an input device(s) interface (e.g., 206 in FIG. 2). However, order entry device 700 of FIG. 7 provides a key for, at least, each price level for both the buy side and the sell side displayed in a trading screen. So, for example, keys 702-724 are mapped to price levels “104” through “93” (e.g., price levels displayed in trading screens shown in FIGS. 4 and 5) to send buy orders, and keys 726-748 are mapped to price levels “104” through “93” to send sell orders. Keys 750 and 752 may perform similar functions to keys 422 and 424 in FIG. 4 to change the mapping of the keys to the price levels.

FIG. 8 shows a similar order entry device 800 to that of order entry device 700 shown in FIG. 7 except it also includes an output display 802. Thus, order entry device 800 may be connected to both an input device(s) interface and the display device(s) interface (e.g., 206 and 208 in FIG. 2, respectively).

Referring to FIG. 8, it might be beneficial to have indicators 802 displayed on order entry device 800 to highlight certain items of interest. For example, to assist the trader in determining where the inside market is relative to the set of keys 802-824 and set of keys 826-848, indicators at the inside market prices could light up. Additionally, those price levels with market depth could also light up with either the same or different color. Also, more indicators (not shown in the figure) could be used to highlight price levels where the trader has working orders in the market. More sophisticated indicators could also be used at each price level such as digital readouts to digitally output things such as the actual price levels, the quantity at given price levels, working orders, last traded price, last traded quantity, and so on.

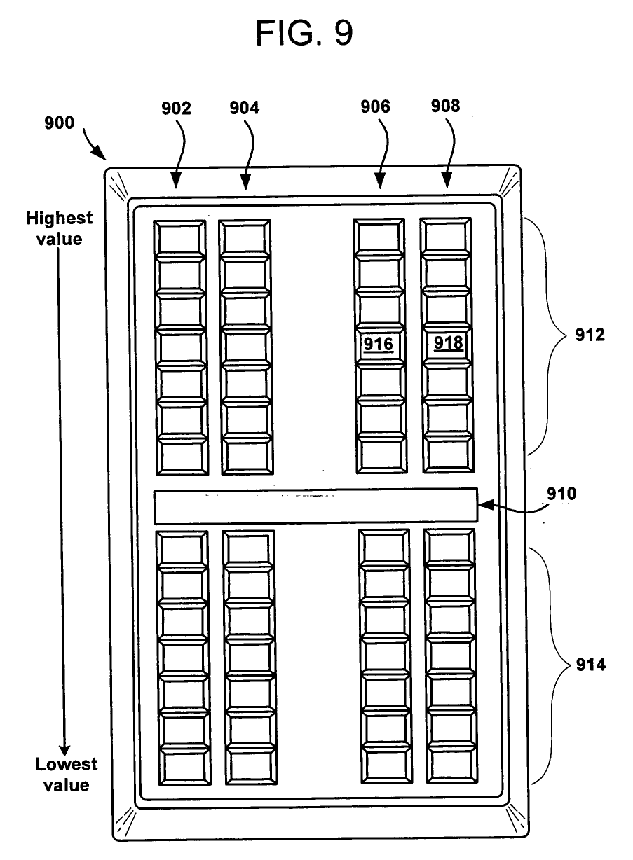

FIG. 9 shows another order entry device 900 that has keys mapped to a series of price levels. As explained in relation to earlier Figures, the mapping between the keys and the price levels could be static or dynamic in nature, and a user could control the operation mode of the order entry device 900. Also, the order entry device 900 of FIG. 9 can be of the only-input type, such as described in relation to FIG. 7, or can be connected to both an input device(s) interface and the display device(s) interface, as explained in relation to FIG. 8. The order entry device 900 provides a key for, at least, each price level up to a certain number of prices levels for both the buy side and the sell side. For example, the fourteen keys, referred to generally as keys 904, may correspond to fourteen price levels on the buy side, and fourteen keys, referred to generally as keys 906, may correspond to fourteen price levels on the sell side. Of course, more or fewer number of price levels may be mapped. Also, the price levels may be arranged in numerical order along an axis having a price of highest value at a first end of the axis and having a price of the lowest level at the second end of the axis.

According to one example embodiment, each set of keys may be divided into two groups, the keys corresponding to price levels equal to and higher than the best ask, as shown at 912, and the keys corresponding to price levels equal to and lower than the best bid, as shown at 914. The illustration in FIG. 9 is not limiting, but rather provides an example for illustrative purposes. One of ordinary skill in the art will appreciate that the keys may be arranged in other ways beside the arrangement shown in FIG. 9 while accomplishing a similar result. For instance, keys corresponding to the best ask and best bid may be placed near each other (not shown in FIG. 9), while keys corresponding to price levels higher than and lower than the inside market may be so divided.

As illustrated in FIG. 9, the two groups of keys may be divided by a divider, such as a bar 910, so that a user can easily locate the keys corresponding to prices higher and lower than the inside market prices. In one example embodiment, the divider is positioned near the center of the axis, but different embodiments are possible as well. However, it should be understood that different embodiments could also be used to distinguish the two groups of keys. For example, one group of keys could have a different appearance or imprint so that a user could distinguish each set of keys upon looking or touching the two sets of keys.

As mentioned in relation to earlier figures, sometimes, inside market prices may be centered around one or more price levels with no pending order quantities (e.g., a gap between the best ask and the best bid). In such an instance, some of the keys 904 and 906, such as keys around the bar 910, could correspond to those prices without pending order quantities. Then, indicators, such as those illustrated in relation to FIG. 8, could be used to highlight which keys correspond to the inside market as the mapping to those keys will change as the gap between the best ask and bid expands or shrinks. Also, according to this embodiment, the divider 910 may split the gap; for example, if the best bid is “98” and the best ask is “101,” then the price levels corresponding to “100” and higher will be mapped to keys above the divider 910 and the price levels corresponding to “99” and lower will be mapped to keys below the divider 910. An indicator may be used to highlight the best bid “98” and the best ask “101.” In another example, if the best bid is “98” and the best ask is “100,” then the price levels corresponding to “99” or “100,” whichever is preferred, and higher will be mapped to keys above the divider, whereas the remaining price levels will be mapped below the divider.

In an alternative embodiment, the indicators could be used to highlight price levels corresponding to prices in between the inside market prices in addition to (or instead of) highlighting the inside market prices; so for example, red indicators may be used to highlight the inside market, whereas green indicators may be used to highlight prices in between the inside market.)

In another alternative embodiment, keys 904 and 906 could be mapped in such a way as to not have any keys that correspond to price levels in between the inside market prices (e.g., having keys starting from the inside market prices and not from price levels, if any, between the best ask and the best bid). However, according to this alternative embodiment, a user could not as easily place an order at a price between the inside market prices because no key is mapped to those prices. So, for example, if the best bid is “98” and the best ask is “100,” then no key is mapped to “99.”

In addition to providing keys that can be used to enter orders at price levels corresponding to each key, the order entry device 900 may also provide additional keys that can be used to take actions in relation to orders pending at the price levels corresponding to each key. FIG. 9 displays two sets of order action related keys, keys 902 corresponding to working buy orders, and keys 908 corresponding to working sell orders. It should be understood that the keys 902 and 908 could correspond to many different order related actions, and the order related action corresponding to the keys could be user-configurable. For example, the keys 902 and 908 could correspond to an order cancellation action. In such an embodiment, for example, when a user enters a sell order using a key 916 (the order is at the price mapped to key 916 with a quantity equal to a preset quantity) corresponding to the ask keys 906, the user could then enter a cancellation request for that order by selecting key 918. It should be understood that different configurations are possible as well. For example, rather than sending a cancellation request for the order quantity corresponding to the last order entered at the price levels associated with the selected order cancellation request, a user could configure the order cancellation keys such that upon selecting one of the keys, a cancellation request for the entire quantity pending at the price corresponding to the selected key will be sent to an exchange. It should be understood that additional order related actions could be provided as well.

Additionally, other actions could take place upon a series of keystrokes of the order action keys. A series of keystrokes that have been assigned a name or key combination may be programmed that when pressed the steps in a macro are executed from beginning to end. For example, pressing a certain combination of keys may result in moving an order to a different price level, changing the order quantity to a preset amount, or perform some other user defined task on the order.

While the example embodiments described in relation to the preceding Figures show at least two keys being associated with a single price level, such that one of the keys is associated with buying a tradeable object and another key is associated with selling the tradeable object at the corresponding price level, different embodiments are possible as well. For example, one key can be provided in relation to a price level, and a user could control whether a buy order or a sell order is sent to an exchange upon selecting the key. In one embodiment, a switch could be provided in relation to the order entry device that could enable a user to switch between the two functionalities of the keys. Alternatively, any other user configured input could be used as well.

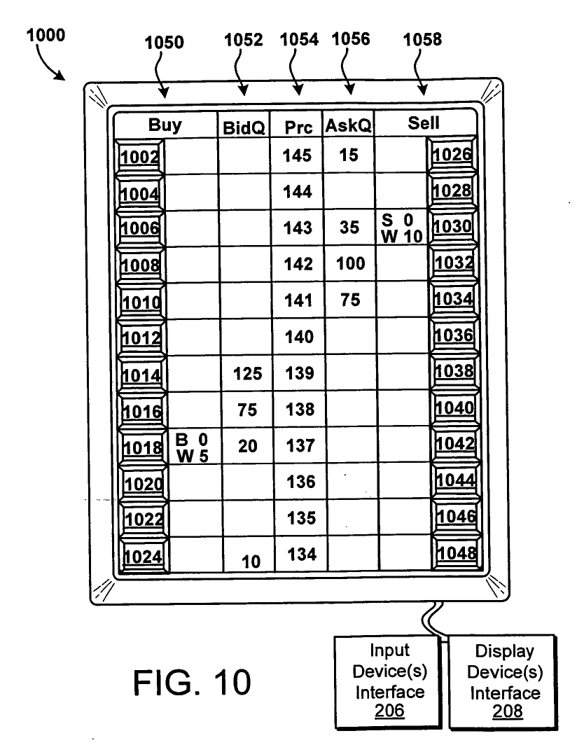

FIG. 10 shows an order entry device 1000 that is similar to order entry device 700 in FIG. 7 except the order entry device 1000 in FIG. 10 has a display screen (made up of display regions 1050-1058) in association with the keys 1002-1024 and 1026-1048. A separate display screen such as from a third party vendor is not necessary according to this preferred embodiment as a trading screen itself is built into the order entry device 1000. Like the order entry device 700 in FIG. 7, the order entry device 1000 may be connected to both the input device(s) interface and the display device(s) interface (e.g., 206 and 208 in FIG. 2).

Any type of display screen technology may be used. For example, the display screen (e.g., display regions 1050-1058 in FIG. 10) can be a liquid crystal display (LCD) or some variation thereof such as a thin film type transistor (TFT) which is a type of LCD display. Alternatively, the display screen can be made up of a gas plasma display, or light emitting diodes (LED), or a series of seven-segment displays, or some other output mechanism. Depending on the technology utilized and the information displayed, the display screen may be made up of only one display or it may be made up of two or more displays or regions of display.

Referring to FIG. 10, the display screen is similar to the electronic trading interface referred to as MD Trader™ in which working orders and/or bid and ask quantities are displayed in association with a price axis, which is described in the above incorporated applications. Of course, more or fewer display regions may be present depending on the amount of information one wishes to view, however for sake of illustration, order entry device 1000 shows a buy region 1050, bid quantity region 1052, price region 1054, ask quantity region 1056, and a sell region 1058. The buy region 1050 shows working orders including the quantity that is working (e.g., a buy order at a price of “137” is currently working “5” in the market represented by “W 5”) and the quantity that is bought (e.g., no quantity of the buy order at “137” has been matched and is represented by “B 0”). Working orders may be represented in other ways. The sell region 1058 shows working sell orders. The bid quantity region 1052 and the ask quantity region 1056 show available bid quantities and available ask quantities at corresponding price levels, respectively. The price region 1054 shows price levels along a price scale or axis. It should be understood that the regions can preferably switched around to display regions in different areas of the display screen.

According to the embodiment shown in FIG. 10, directly associated with each price level are two keys, and in particular, one key for the buy side and one key for the sell side. Keys 1002-1024 are used to send buy orders to an exchange and keys 1026-1048 are used to send sell orders to an exchange. For example, key 1002, when pressed, sends an order to buy a pre-set quantity at a price of “145” and key 1026, when pressed, sends an order to sell a pre-set quantity at a price of “145.”

As the inside market moves up or down along the axis of prices, the price levels in price region 1054 may be re-centered or repositioned so that another set of prices and quantities available at those prices are viewed. When the price levels are re-centered or repositioned, preferably, the mapping to the keys change so that the price levels visible in price region 1054 have associated keys. Re-centering and repositioning are described in U.S. patent application Ser. No. 09/590,692, entitled “Click Based Trading With Intuitive Grid Display of Market Depth,” filed on Jun. 9, 2000, and U.S. patent application Ser. No. 09/971,087, entitled “Click Based Trading With Intuitive Grid Display Of Market Depth And Price Consolidation,” filed on Oct. 5, 2001, the contents of both are incorporated by reference herein. Of course, there are many ways to trigger a repositioning command such as by monitoring changes in the market.

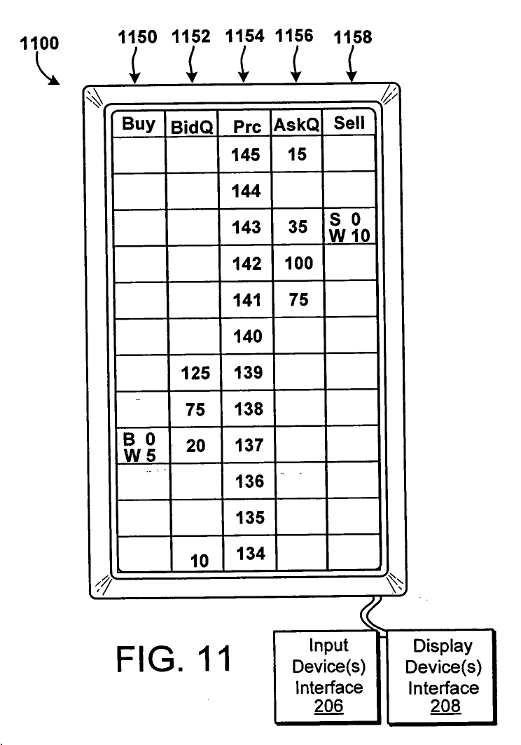

FIG. 11 shows an order entry device 1100 that is similar to the order entry device 1000 in FIG. 10 except the order entry device 1100 in FIG. 11 utilizes touch screen technology. Preferably, the touch screen is of the type that provides tactile feedback to the trader when the soft keys are pressed. For sake of illustration, different types of touch screen technologies may include analog resistive, capacitive, scanning infrared (IR), and surface wave acoustic wave (SAW). In addition to tactile feedback, audio or visual feedback may be provided when a key is selected. For example, when a particular location is selected it might light up or an audio signal is output.

The order entry device 1100 provides a similar layout to the order entry 1100 of FIG. 10. Preferably, the order entry device 1100 allows for regions to be rearranged to suit a trader's particular preferences. The regions displayed in FIG. 11 are similar to the regions displayed in FIG. 10 and includes a buy region 1150, bid quantity region 1152, price region 1154, ask quantity region 1156, and a sell region 1158. More or fewer regions may be included on the screen display.

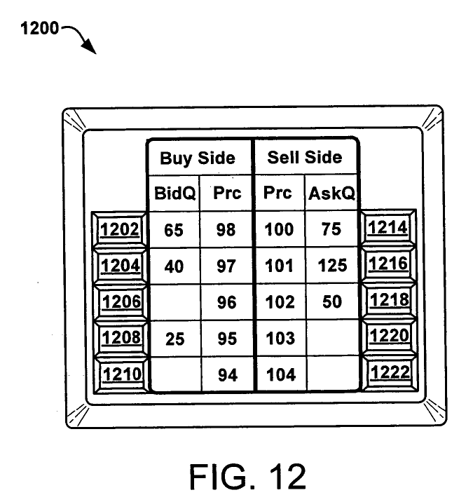

FIG. 12 shows an order entry device 1200 that is similar to the order entry device 1000 in FIG. 10 except the order entry device uses a trading screen of the type shown in FIG. 6. Keys 1202-1210 are mapped to the price levels shown in the price column for the buy side, and keys 1214-1222 are mapped to the price levels shown in the price column for the sell side. According to one particular screen type, the prices in the price column are dynamic. In other words, the prices might not always be in numerical order as they are shown in the Figure.

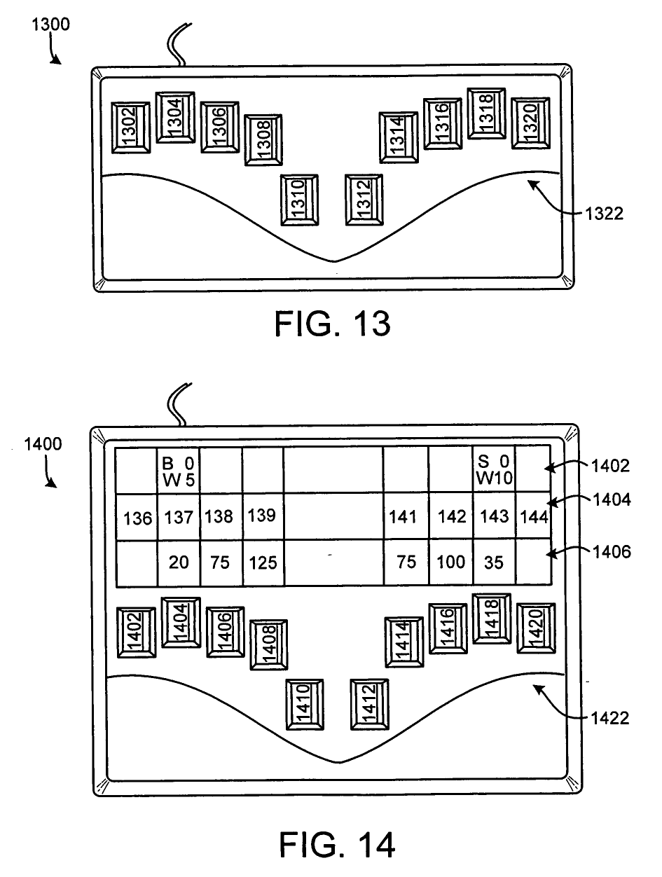

FIG. 13 shows an order entry device 1300 with a horizontal arrangement of keys. Order entry device 1300 is of the only-input type and may be connected to input device(s) interface (e.g., 206 in FIG. 2). Preferably each of the keys 1302-1308 and keys 1314-1320 are mapped to a particular price level for which orders can be placed, and keys 1310 and 1312 may be used to change the mapping in incremental units. Additionally, the controller may be contoured 1322 to the trader's hand for comfort.

FIG. 14 shows an order entry device 1400 that is similar to the order entry device 1300 of FIG. 13 except the order entry device 1400 in FIG. 14 has a display screen (made up of display regions 1402-1406) in association with the keys 1402-1408 and keys 1414-1420. Display regions 1402-1406 are similar to function as display regions 1050-1058 in FIG. 10.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are examples only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. Thus, all variations that come within the scope and spirit of the following claims and equivalents thereto are claimed as the invention.

1. A method of placing a trade order for a tradeable object on an electronic exchange, the method comprising:
establishing a fixed association between a plurality of prices and a plurality of buttons, each price being associated with two buttons and each of the two buttons being associated with either buying a tradeable object or selling the tradeable object at the corresponding price;
receiving a selection of a button;
determining the association between the selected button and one of the plurality of prices and whether the selected button corresponds to buying or selling the tradeable object;
when the selected button corresponds to buying the tradeable object, sending an order to buy the tradeable object at the determined price to an electronic exchange; and
when the selected button corresponds to selling the tradeable object, sending an order to sell the tradeable object at the determined price to the electronic exchange.

2-20. (canceled)
